(19) United States
(12) Patent Application Publication
(10) Pub. No.: US 2008/0239893 A1
(43) Pub. Date: Oct. 2, 2008

(54) Optical Disc Apparatus

(75) Inventor: Takeyoshi Kataoka, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignees: Hitachi, Ltd; Hitachi-LG Data Storage, Inc.

(21) Appl. No.: 12/053,790

(22) Filed: Mar. 24, 2008

(30) Foreign Application Priority Data
Mar. 26, 2007 (JP) 2007-078135

(51) Int. Cl. G11B 7/09

(52) U.S. Cl. 369/44.29

(57) ABSTRACT

An optical disc apparatus capable of conducting seek processing stably. If an angle is given to an objective lens in a radial direction by using an actuator at the time of seek processing, then it is possible to correct deviation between an amplitude center of a tracking error signal obtained when crossing a track and a level obtained when a tracking servo system is in the on-state, which is caused by an objective lens getting out of a center of intensity distribution of laser light. The deviation can also be improved by adding an offset to the tracking error signal. Therefore, stable seek processing is conducted by conducting tilt correction or adding an offset to the tracking error signal, according to a movement condition.

### INCORPORATION BY REFERENCE

The present application claims priority from Japanese application JP2007-078135 filed on Mar. 26, 2007, the content of which is hereby incorporated by reference into this application.

### BACKGROUND OF THE INVENTION

The present invention relates to an optical disc apparatus.

### SUMMARY OF THE INVENTION

In an optical disc apparatus, there is seek processing for moving an objective lens of an optical pickup to read data recorded on a predetermined address.

In the seek processing, an optical pickup and an objective lens mounted on the optical pickup and activated by an actuator are moved in a radial direction with a tracking servo system being in the off-state and a focus servo system being in the on-state, and an optical spot is moved to a desired address with the tracking servo system being in the on-state.

When an optical disc is inserted into the optical disc apparatus, typically the movement direction of the objective lens is not parallel to the information recording surface of the optical disc. This is because there is a warp in the optical disc itself and inclination is caused according to a state of attaching the optical disc to the optical disc apparatus. As its angle difference becomes large, aberration is caused between the optical disc and the optical system and degradation is caused in the recording and reproducing performance. Therefore, it has been devised to correct the aberration by moving the objective lens in the tilt direction.

A tilt correction mechanism in the optical disc apparatus and the relation between the seek processing time and the tilt correction is described in JP-A-2003-22554. It is described that there is a warp in the optical disc and a suitable tilt correction quantity differs according to the radial position and consequently the tilt correction quantity is varied in the seek processing.

In the seek processing, the objective lens sometimes moves ahead and gets out of the center of intensity distribution of laser light. There is a problem that the amplitude center of the tracking error signal at the time of track crossing deviates from the level obtained when the tracking servo system is in the on-state.

This problem becomes remarkable when the DPD scheme is used as compared with when the tracking error signal detection method uses the DPP scheme utilizing the push-pull scheme. It is considered that this problem is a problem caused by precision of components of the optical pickup and attachment precision. However, this problem is not considered at all in JP-A-2003-22554.

An object of the present invention is to provide an optical disc apparatus which conducts seek processing stably.

The object of the present invention can be achieved by, for example, conducting tilt correction or adding an offset to the tracking error signal.

According to the present invention, an optical disc apparatus which conducts seek processing stably can be provided.

Other objects, features and advantages of the invention will become apparent from the following description of the embodiments of the invention taken in conjunction with the accompanying drawings.

### BRIEF DESCRIPTION OF THE DRAWINGS

FIGS. 1A and 1B are diagrams for explaining seek processing;

FIG. 2 is a block diagram showing a configuration of an optical disc apparatus according to a first embodiment;

FIG. 3 is a flow chart of the optical disc apparatus shown in FIG. 2;

FIG. 4 is a diagram for explaining a tilt correction value in seek processing;

FIG. 5 is a flow chart;

FIG. 6 is a block diagram showing a configuration of an optical disc apparatus according to a second embodiment;

FIG. 7 is a flow chart of the optical disc apparatus shown in FIG. 6;

FIG. 8 is a diagram for explaining an offset value in seek processing;

FIG. 9 is a diagram for explaining a tilt correction value in seek processing in a third embodiment; and

FIG. 10 is a flow chart in the third embodiment.

### DETAILED DESCRIPTION OF THE EMBODIMENTS

Hereafter, embodiments of the present invention will be described specifically with reference to the drawings.

The problem found by the present inventor will now be described in more detail.

In the conventional technique, the tilt is corrected according to inclination of the laser light incidence angle with respect to the information recording surface of the optical disc. Especially if the optical pickup moves in the radial direction in the seek processing, the relation between the optical disc and the incidence angle of laser light is changed by the warp or the like of the optical disc and it is sometimes necessary to conduct tilt correction on the objective lens so as to make the objective lens suitable for recording or reproducing according to the change.

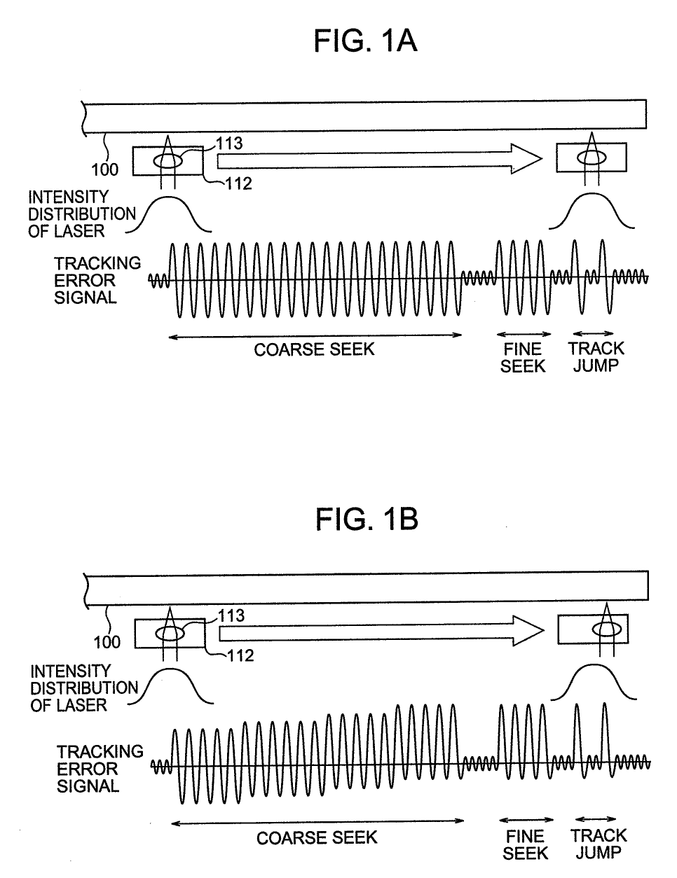

The seek processing includes coarse retrieval processing for largely moving an optical spot formed on the information recording surface of the optical disc, fine retrieval processing for moving the optical spot small, and a track jump for moving the optical spot by one track. A tracking error signal has a waveform as shown in FIG. 1A. At this time, the amplitude center of the tracking error signal at the time of crossing a track is substantially equivalent to the level of the tracking error signal with the tracking servo system being in the on-state. It is desirable in the optical disc apparatus that the objective lens is located near the center of the intensity distribution of the laser light. In the seek processing, however, the objective lens sometimes moves ahead and gets out of the center of intensity distribution of laser light. At this time, the amplitude center of the tracking error signal at the time of track crossing sometimes deviates from the level obtained when the tracking servo system is in the on-state as shown in FIG. 1B.

The optical pickup is typically designed so as not to cause such deviation of the signal level. In some cases, however, such a problem is caused under influence of aberration which is brought about by, for example, variations in construction. This leads to aggravation of the tracking servo performance and stability degradation in the seek processing.

This problem is not apt to occur when the DPP scheme utilizing the push-pull scheme is used as the tracking error signal detection method. The problem is posed by the precision of components of the optical pickup and attachment precision when the DPD scheme is used.

In the DPP scheme, there are a main optical spot and sub spots deviated by half a track before and after the main spot, respectively. The tracking error signal is generated from reflected light beams of the optical spot reflected from an upper part and a lower part of a track groove. If the main spot is adjusted so as to have no offset when the objective lens is in the center of the intensity distribution of the laser, an offset occurs in the signal obtained when the objective lens gets out of the center of the intensity distribution. The sub spot can be detected as a signal of an opposite phase with an offset of nearly the same level as that of the main spot by adjusting the gain level and the offset. By using a difference between the main spot signal and the sub spot signal, the offset is canceled and the offset is not to apt to occur in the tracking error signal even if the objective lens deviates from the center of the intensity center of the laser. However, the relation between the track groove depth and the laser light wavelength is important. Detection of the tracking error signal is difficult in some cases depending upon the level of groove depth.

On the other hand, the DPD scheme is a scheme in which the tracking error signal is generated by one optical spot. There are lands and grooves on the optical disc. If data are recorded on grooves, the tracking error signal is generated from a difference in reflected light quantity between a groove having data recorded thereon and a land having no data recorded thereon. In the DPD scheme, the tracking error signal can be generated regardless of the level of the groove depth. However, it is necessary that data are already recorded. Furthermore, the offset is apt to occur in the tracking error signal as compared with the DPP scheme.

Depending upon the groove depth and pit depth, therefore, there are cases where detection of the tracking error signal using the DPP scheme is difficult. In such a case, the amplitude center of the tracking error signal at the time of track crossing deviates from the level obtained when the tracking servo system is in the on-state, resulting in a problem. Hereafter, embodiments will be described on the basis of the foregoing description.

### First Embodiment

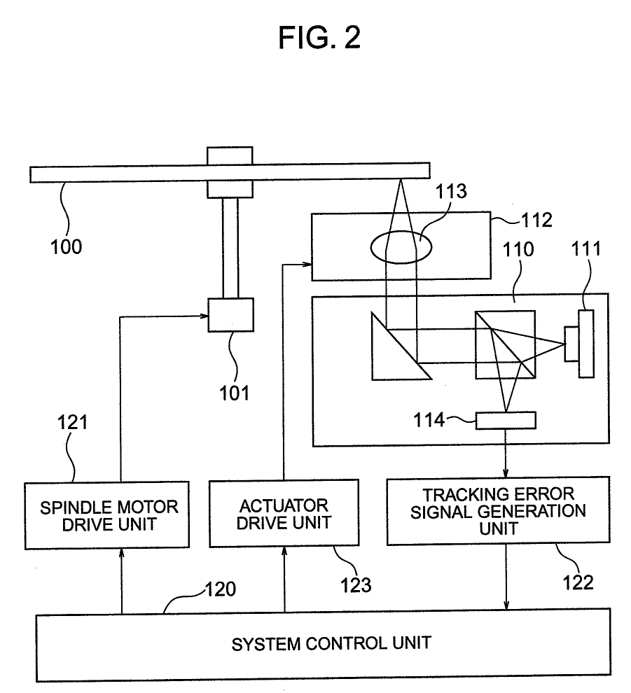

FIG. 2 is a block diagram showing a configuration of an optical disc apparatus according to a first embodiment.

Information reading, erasing and writing are conducted by irradiating an optical disc 100 with laser light emitted from an optical pickup 110. In addition, the optical disc 100 is rotated by a spindle motor 101 driven by a spindle motor drive unit 121 which receives a signal from a system control unit 120.

Laser light emitted from a semiconductor laser 111 is focused on an information recording surface of the optical disc 100 as an optical spot by an objective lens 113 moved by an actuator 112, reflected by the information recording surface of the optical disc 100, and detected by a photodetector 114. A tracking error signal generated from a signal detected by the photodetector 114 by a tracking error signal generation unit 122 is input to the system control unit 120, and read as a signal which indicates an error quantity between the optical spot and a track. The actuator 112 is driven by an actuator drive unit 123 which receives a signal from the signal control unit 120. The actuator 112 moves the objective lens 113 in the radial direction of the optical disc 100 and in the focus direction. Furthermore, the actuator 112 conducts tilt correction by giving an angle in the radial direction. The seek processing means moving the optical pickup 110 including the objective lens 113 in the radial direction of the optical disc 100 and moving the optical spot to a desired address.

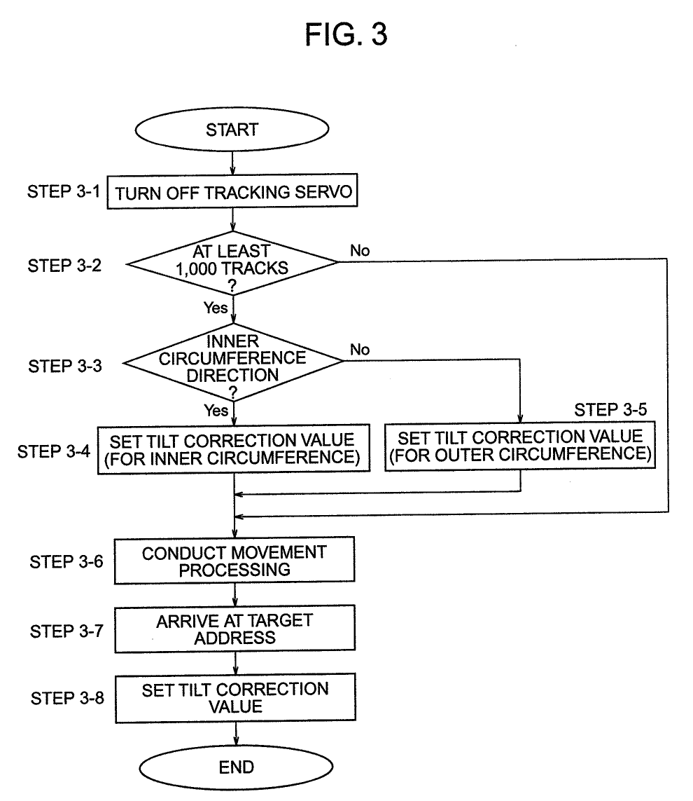

A method of setting a tilt correction value at the time of seek processing and conducting stable seek processing will be described specifically with reference to a flow chart shown in FIG. 3.

First, the tracking servo system is brought into the off-state (step 3-1). A decision is made whether the number of tracks over which movement in the seek processing is to be conducted is at least 1,000 (step 3-2). If the number of tracks over which the movement is to be conducted is judged at the step 3-2 to be at least 1,000, a decision is made whether the movement is to be conducted in the inner circumference direction or in the outer circumference direction (step 3-3). If the movement is judged at the step 3-3 to be conducted in the inner circumference direction, a tilt correction value for the inner circumference is set according to a target address (step 3-4). If the movement is judged at the step 3-3 to be conducted in the outer circumference direction, a tilt correction value for the outer circumference is set according to the target address (step 3-5). After the step 3-4 or the step 3-5, movement processing using coarse seek and track jump is conducted (step 3-6). Since the tilt correction value is set at this time, the seek processing can be conducted stably. If the number of tracks over which the movement is to be conducted is judged at the step 3-2 to be less than 1,000, then it is supposed that the objective lens 113 does not get out of the center of the intensity distribution of laser light so much, and the tilt correction value is not changed, but the movement processing (step 3-6) is conducted. As a result of the movement processing at the step 3-6, the target address is arrived at (step 3-7). The tilt correction value is set equal to a predetermined value (step 3-8) and the seek processing is finished. “The tilt correction value is set equal to a predetermined value” at the step 3-8 means that the tilt correction value is set equal to a value suitable for recording or reproducing data when the objective lens 113 is located near the center of the intensity distribution of laser light.

A method for finding setting quantities of the tilt correction value set at the step 3-4 and the step 3-5 will now be described. In each of the inner circumference part and the outer circumference part of the optical disc 100, the focus servo system is in the on-state and the tracking servo system is not in the on-state. In the state in which the optical spot is crossing a track, the actuator 112 moves the objective lens 113 from the vicinity of the center of intensity distribution of laser light to the inner circumference side or the outer circumference side. As a result, the amplitude center of the tracking error signal obtained when crossing a track deviates from the level obtained when the tracking servo system is in the on-state. In this state, the tilt is corrected in a direction that the amplitude center of the tracking error signal obtained when crossing a track approaches the level obtained when the tracking servo system is in the on-state. A tilt correction quantity at which the amplitude center becomes nearly equal to the above-described level is found, and the tilt correction quantity is adopted as the tilt correction value.

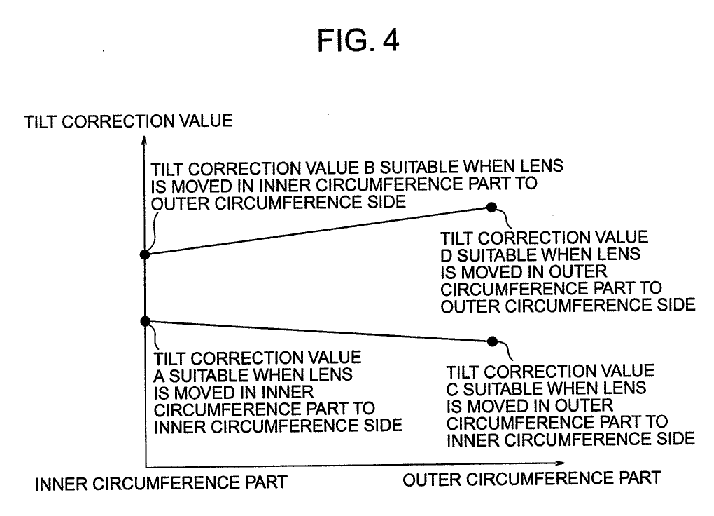

As shown in FIG. 4, a suitable value when the objective lens 113 is moved in the inner circumference part of the optical disc 100 to the inner circumference side is denoted by tilt correction value A. A suitable value when the objective lens 113 is moved in the inner circumference part to the outer circumference side is denoted by tilt correction value B. A suitable value when the objective lens 113 is moved in the outer circumference part of the optical disc 100 to the inner circumference side is denoted by tilt correction value C. A suitable value when the objective lens 113 is moved in the outer circumference part to the outer circumference side is denoted by tilt correction value D. As regards other areas, calculation is conducted from the four correction values to supplement.

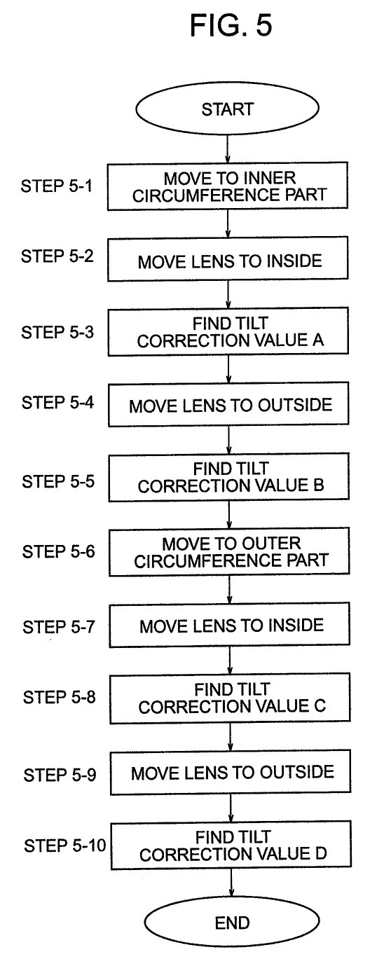

How to find the correction value concretely will now be described with reference to a flow chart shown in FIG. 5. The objective lens 113 is moved to the inner circumference part of the optical disc 100 (step 5-1). At this time, the focus servo system is in the on-state, whereas the tracking servo system is in the off-state, and the optical spot is crossing a track. The actuator 112 moves the objective lens 113 from the center of intensity distribution of laser light to the inside in the radial direction by a predetermined quantity (step 5-2). The actuator 112 is driven, and the tilt correction value A is found so as to cause the amplitude center of the tracking error signal obtained when crossing a track to become nearly the same as the level obtained when the tracking servo system is in the on-state (step 5-3). The objective lens 113 is moved from the center of the intensity distribution of laser light to the outside in the radial direction by a predetermined quantity (step 5-4). The actuator 112 is driven, and the tilt correction value B is found so as to cause the amplitude center of the tracking error signal obtained when crossing a track to become nearly the same as the level obtained when the tracking servo system is in the on-state (step 5-5). The objective lens 113 is moved to the outer circumference part of the optical disc 100 (step 5-6). In the same way as the operation in the inner circumference part, the focus servo system is in the on-state, whereas the tracking servo system is in the off-state, and the optical spot is crossing a track. The actuator 112 moves the objective lens 113 from the center of the intensity distribution of laser light to the inside in the radial direction by a predetermined quantity (step 5-7). The actuator 112 is driven, and the tilt correction value C is found so as to cause the amplitude center of the tracking error signal obtained when crossing a track to become nearly the same as the level obtained when the tracking servo system is in the on-state (step 5-8). The objective lens 113 is moved from the center of the intensity distribution of laser light to the outside in the radial direction by a predetermined quantity (step 5-9). The actuator 112 is driven, and the tilt correction value D is found so as to cause the amplitude center of the tracking error signal obtained when crossing a track to become nearly the same as the level obtained when the tracking servo system is in the on-state (step 5-10).

As heretofore described, stable seek processing can be conducted by setting tilt correction values for the seek processing.

By the way, in the present embodiment, the seek processing time can be shortened by previously finding the tilt correction values required for stable seek processing.

### Second Embodiment

In the first embodiment, it is attempted to stabilize the servo performance by setting the tilt correction values at the time of seek processing. In the present embodiment, however, stabilization is attempted by adding the offset to the tracking error signal.

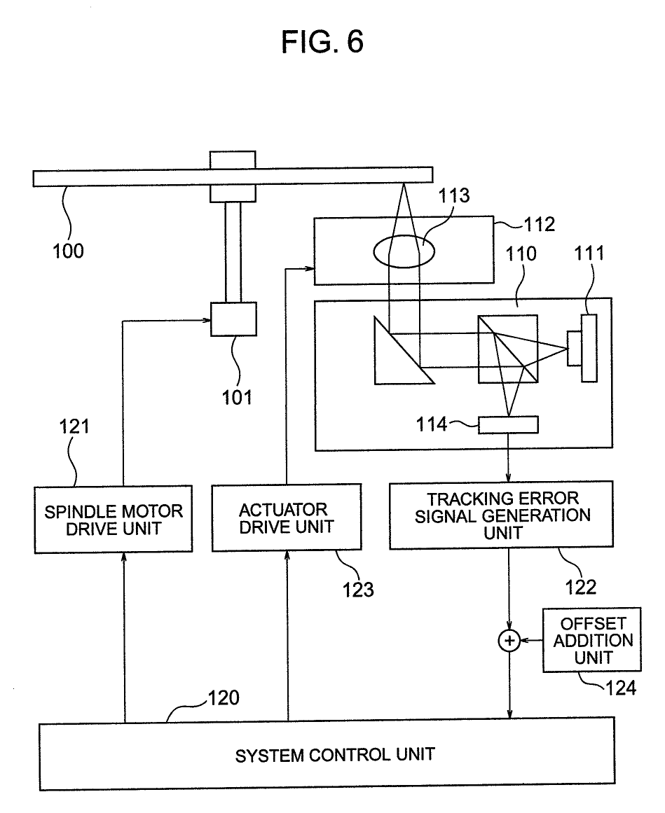

FIG. 6 is a block diagram showing a configuration of an optical disc apparatus according to the present embodiment. An offset addition unit 124 is added to the optical disc apparatus shown in FIG. 2. The offset addition unit 124 can add an arbitrary offset to the tracking error signal. The offset addition unit 124 may be incorporated in the system control unit 120 or the tracking error signal generation unit 122.

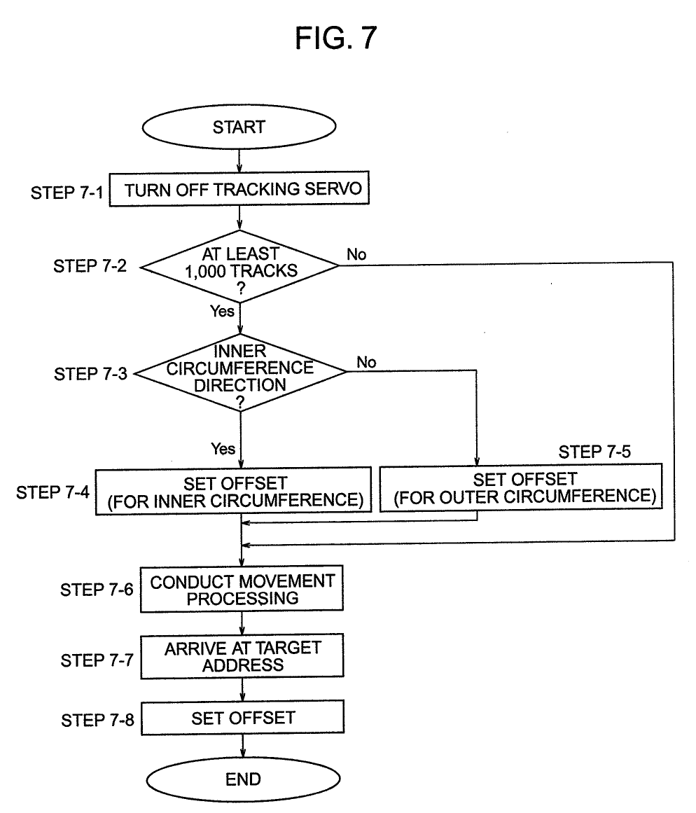

A sequence in the present embodiment will now be described specifically with reference to a flow chart shown in FIG. 7.

First, the tracking servo system is brought into the off-state (step 7-1). A decision is made whether the number of tracks over which movement in the seek processing is to be conducted is at least 1,000 (step 7-2). If the number of tracks over which the movement is to be conducted is judged at the step 7-2 to be at least 1,000, a decision is made whether the movement is to be conducted in the inner circumference direction or in the outer circumference direction (step 7-3). If the movement is judged at the step 7-3 to be conducted in the inner circumference direction, an offset value for the inner circumference is set according to a target address (step 7-4). If the movement is judged at the step 7-3 to be conducted in the outer circumference direction, an offset value for the outer circumference is set according to the target address (step 7-5). After the step 7-4 or the step 7-5, movement processing using coarse seek and track jump is conducted (step 7-6). Since the offset value is set at this time, the seek processing can be conducted stably. If the number of tracks over which the movement is to be conducted is judged at the step 7-2 to be less than 1,000, then it is supposed that the objective lens 113 does not get out of the center of the intensity distribution of laser light so much, and the offset value is not changed, but the movement processing (step 7-6) is conducted. As a result of the movement processing at the step 7-6, the target address is arrived at (step 7-7). The offset value is set equal to a predetermined value (step 7-8) and the seek processing is finished. “The offset value is set equal to a predetermined value” at the step 7-8 means that the offset value is set equal to a value suitable for recording or reproducing data when the objective lens 113 is located near the center of the intensity distribution of laser light.

A method for finding setting quantities of the offset value set at the step 7-4 and the step 7-5 will now be described. The optical disc 100 is divided into five areas ranging from zone 1 to zone 5. Near the head address of each area, the focus servo system is in the on-state and the tracking servo system is not in the on-state. In the state in which the optical spot is crossing a track, the objective lens 113 is moved from the vicinity of the center of intensity distribution of laser light to the inner circumference side or the outer circumference side. At this time, the offset value is changed and a suitable value is found so as to cause the amplitude center of the tracking error signal obtained when crossing a track to approach the level obtained when the tracking servo system is in the on-state.

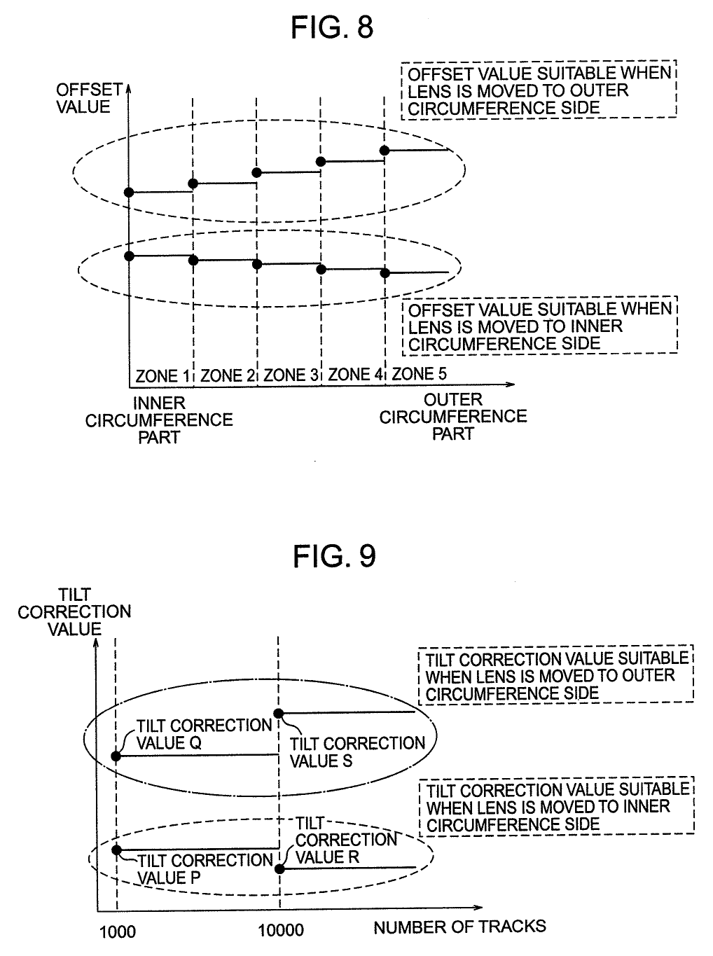

As shown in FIG. 8, offset values found when the objective lens 113 is moved to the inner circumference side and the outer circumference side at the head of each zone are set as values of the zone at the time of seek processing. In FIG. 8, correction values are found near the head address of each zone. However, the correction values may be found anywhere as long as the place is in the zone.

In the present embodiment, it is not conducted to give an angle by setting tilt correction values and physically moving the objective lens 113, unlike the first embodiment. Since it suffices to electrically set the offset in the present embodiment, it becomes possible to conduct the processing in a shorter time as compared with the first embodiment.

By the way, in the present embodiment, the seek processing time can be shortened by previously finding the offset values required for stable seek processing.

### Third Embodiment

The method described in the first embodiment is intended for the case where the tilt correction value required to correct the deviation between the amplitude center of the tracking error signal obtained when crossing a track and the level obtained when the tracking servo system is in the on-state differs according to the address, when the objective lens 113 is moved from the vicinity of intensity distribution of laser light by the same quantity in the inner circumference part and the outer circumference part of the optical disc 100. In a method which will be described in the present embodiment, the tilt correction quantity required to correct the deviation between the amplitude center of the tracking error signal obtained when crossing a track and the level obtained when the tracking servo system is in the on-state is set according to the number of tracks over which movement is conducted by the seek processing.

The present embodiment has the configuration shown in FIG. 2 in the same way as the first embodiment.

FIG. 9 shows relations between tilt correction values and the number of movement tracks.

If the number of movement tracks is less than 1,000, the setting of the tilt correction value is not changed before the seek processing in the same way as the first embodiment. The tilt correction quantity differs according to whether the number of movement tracks is at least 1,000 and less than 10,000, or at least 10,000. Furthermore, the tilt correction value differs according to whether the movement is movement to the inner circumference part or the outer circumference part in the same way as the first embodiment. In the present embodiment, a tilt correction quantity suitable for the case where the number of movement tracks is at least 1,000 and less than 10,000 and the movement is movement to the inner circumference part is denoted by tilt correction value P. A tilt correction quantity suitable for the case where the number of movement tracks is at least 1,000 and less than 10,000 and the movement is movement to the outer circumference part is denoted by tilt correction value Q. A tilt correction quantity suitable for the case where the number of movement tracks is at least 10,000 and the movement is movement to the inner circumference part is denoted by tilt correction value R. A tilt correction quantity suitable for the case where the number of movement tracks is at least 10,000 and the movement is movement to the outer circumference part is denoted by tilt correction value S.

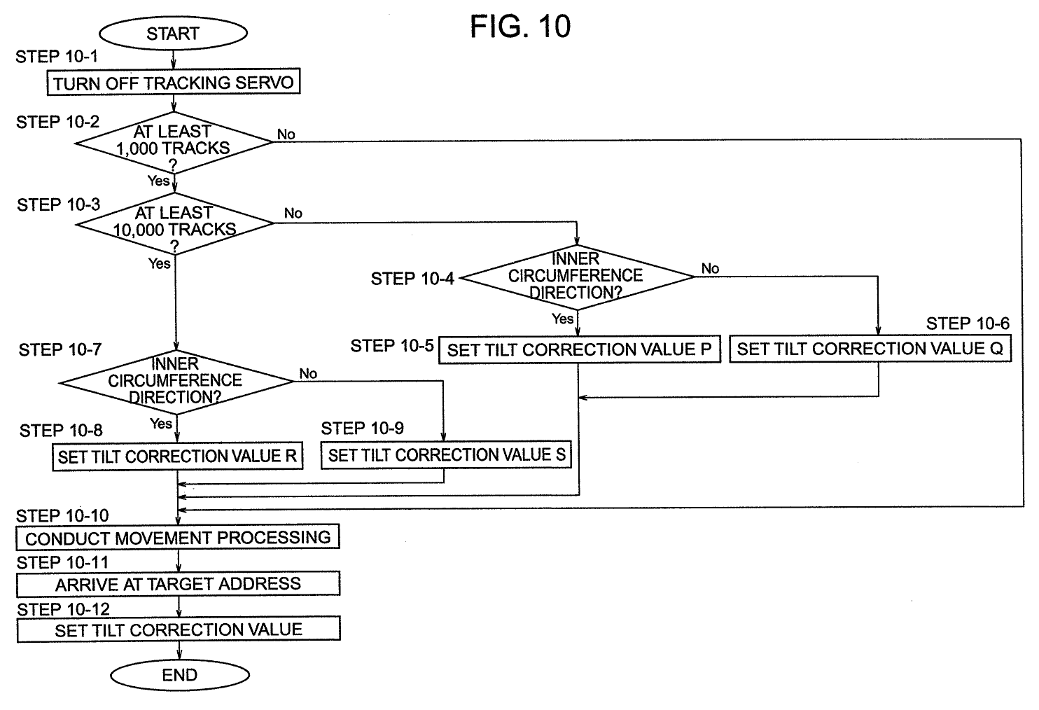

A sequence in the present embodiment will now be described specifically with reference to a flow chart shown in FIG. 10.

First, the tracking servo system is brought into the off-state (step 10-1). A decision is made whether the number of tracks over which movement in the seek processing is to be conducted is at least 1,000 (step 10-2). If the number of tracks over which the movement is to be conducted is judged at the step 10-2 to be at least 1,000, then a decision is made whether the number of tracks over which the movement in the seek processing is to be conducted is at least 10,000 (step 10-3). If the number of tracks over which the movement is to be conducted is judged at the step 10-3 to be less than 10,000, then a decision is made whether the movement is to be conducted in the inner circumference direction or in the outer circumference direction (step 10-4). If the movement is judged at the step 10-4 to be conducted in the inner circumference direction, the tilt correction value P is set (step 10-5). If the movement is judged at the step 10-4 to be conducted in the outer circumference direction, the tilt correction value Q is set (step 10-6). If the number of tracks over which the movement is to be conducted is judged at the step 10-3 to be at least 10,000, then a decision is made whether the movement is to be conducted in the inner circumference direction or in the outer circumference direction (step 10-7). If the movement is judged at the step 10-7 to be conducted in the inner circumference direction, the tilt correction value R is set (step 10-8). If the movement is judged at the step 10-7 to be conducted in the outer circumference direction, the tilt correction value S is set (step 10-9). After the step 10-5, the step 10-6, the step 10-8 or the step 10-9, movement processing using coarse seek and track jump is conducted (step 10-10). Since the tilt correction value is set at this time, the seek processing can be conducted stably. If the number of tracks over which the movement is to be conducted is judged at the step 10-2 to be less than 1,000, then it is supposed that the objective lens 113 does not get out of the center of the intensity distribution of laser light so much, and the tilt correction value is not changed, but the movement processing (step 10-10) is conducted. As a result of the movement processing at the step 10-10, the target address is arrived at (step 10-11). The tilt correction value is set equal to a predetermined value (step 10-12) and the seek processing is finished. “The tilt correction value is set equal to a predetermined value” at the step 10-12 means that the tilt correction value is set equal to a value suitable for recording or reproducing data when the objective lens 113 is located near the center of the intensity distribution of laser light.

In the present embodiment, the numbers of tracks 1,000 and 10,000 are used as thresholds. However, the thresholds may be changed suitably every optical disc apparatus.

Even in the case where the tilt correction quantity is set according to the number of tracks over which movement is to be conducted in the seek processing as described in the present embodiment, it can be coped with by changing the offset value as described in the second embodiment.

It should be further understood by those skilled in the art that although the foregoing description has been made on embodiments of the invention, the invention is not limited thereto and various changes and modifications may be made without departing from the spirit of the invention and the scope of the appended claims.

1. An optical disc apparatus for reproducing information from an optical disc or recording information onto the optical disc by using laser light, the optical disc apparatus comprising:
an objective lens for focusing laser light onto the optical disc;
an actuator for moving the objective lens in a radial direction of the optical disc and adjusting a tilt of the objective lens;
a photodetector for detecting reflected light from the optical disc; and
a tracking error signal generation unit for generating a tracking error signal from a signal output from the photodetector,
wherein, in seek processing for moving the objective lens in the radial direction of the optical disc, a tilt adjustment quantity of the objective lens is changed by the actuator.

2. The optical disc apparatus according to claim 1, wherein when changing a tilt adjustment quantity of the objective lens by using the actuator in the seek processing, the tilt adjustment quantity is set according to a target address.

3. The optical disc apparatus according to claim 1, wherein when changing a tilt adjustment quantity of the objective lens by using the actuator in the seek processing, the tilt adjustment quantity is set according to a movement direction in the seek processing.

4. The optical disc apparatus according to claim 1, wherein when changing a tilt adjustment quantity of the objective lens by using the actuator in the seek processing, the tilt adjustment quantity is set according to a quantity of tracks over which movement is to be conducted.

5. The optical disc apparatus according to claim 1, wherein after changing a tilt adjustment quantity of the objective lens by using the actuator and arriving at a target address in the seek processing, the tilt adjustment quantity is set equal to a value suitable for data recording or reproducing.

6. The optical disc apparatus according to claim 1, wherein in the seek processing the tilt adjustment quantity is set so as to cause a center level of amplitude of the tracking error signal obtained when crossing a track to approach a level of the tracking error signal obtained when tracking servo is in the on-state.

7. The optical disc apparatus according to claim 2, wherein in the seek processing a tilt adjustment quantity which should be set according to a target address and a movement direction are set by:
moving, at an address in an inner circumference part and an address in an outer circumference part of the optical disc, the objective lens in an inner circumference direction and in an outer circumference direction by using the actuator;
finding a tilt adjustment quantity so as to cause a center level of amplitude of the tracking error signal obtained when crossing a track to approach a level of the tracking error signal obtained when tracking servo is in the on-state; and
conducting interpolation in other areas on the basis of results of the finding.

8. The optical disc apparatus according to claim 2, wherein in the seek processing a tilt adjustment quantity which should be set according to a target address and a movement direction are set by:
moving, at an address of each of a plurality of areas obtained by dividing the optical disc, the objective lens in an inner circumference direction and in an outer circumference direction by using the actuator;
finding at that time a tilt adjustment quantity so as to cause a center level of amplitude of the tracking error signal obtained when crossing a track to approach a level of the tracking error signal obtained when tracking servo is in the on-state; and
storing results of the finding as a table.

9. The optical disc apparatus according to claim 3, wherein in the seek processing a tilt adjustment quantity which should be set according to a target address and a movement direction are set by:
moving, at an address in an inner circumference part and an address in an outer circumference part of the optical disc, the objective lens in an inner circumference direction and in an outer circumference direction by using the actuator;
finding a tilt adjustment quantity so as to cause a center level of amplitude of the tracking error signal obtained when crossing a track to approach a level of the tracking error signal obtained when tracking servo is in the on-state; and
conducting interpolation in other areas on the basis of results of the finding.

10. The optical disc apparatus according to claim 3, wherein in the seek processing a tilt adjustment quantity which should be set according to a target address and a movement direction are set by:
moving, at an address of each of a plurality of areas obtained by dividing the optical disc, the objective lens in an inner circumference direction and in an outer circumference direction by using the actuator;
finding at that time a tilt adjustment quantity so as to cause a center level of amplitude of the tracking error signal obtained when crossing a track to approach a level of the tracking error signal obtained when tracking servo is in the on-state; and
storing results of the finding as a table.

11. An optical disc apparatus for reproducing information from an optical disc or recording information onto the optical disc by using laser light, the optical disc apparatus comprising:
an objective lens for focusing laser light onto the optical disc;
an actuator for moving the objective lens in a radial direction of the optical disc and adjusting a tilt of the objective lens;
a photodetector for detecting reflected light from the optical disc;
a tracking error signal generation unit for generating a tracking error signal from a signal output from the photodetector; and
an offset addition unit for adding an offset to the tracking error signal generated by the tracking error signal generation unit, wherein, in seek processing for moving the objective lens in the radial direction of the optical disc, an offset value to be added to the tracking error signal is changed by the offset addition unit.

12. The optical disc apparatus according to claim 11, wherein when changing an offset value to be added to the tracking error signal by using the offset addition unit in the seek processing, the offset value is set according to a target address.

13. The optical disc apparatus according to claim 11, wherein when changing an offset value to be added to the tracking error signal by using the offset addition unit in the seek processing, the offset value is set according to a movement direction in the seek processing.

14. The optical disc apparatus according to claim 11, wherein when changing an offset value to be added to the tracking error signal by using the offset addition unit in the seek processing, the offset value is set according to a quantity of tracks over which movement is to be conducted.

15. The optical disc apparatus according to claim 11, wherein after changing an offset value to be added to the tracking error signal by using the offset addition unit, and arriving at a target address in the seek processing, the offset value is set equal to a value suitable for data recording or reproducing.

16. The optical disc apparatus according to claim 11, wherein in the seek processing the offset value is set so as to cause a center level of amplitude of the tracking error signal obtained when crossing a track to approach a level of the tracking error signal obtained when tracking servo is in the on-state.

17. The optical disc apparatus according to claim 12, wherein in the seek processing an offset value which should be set according to a target address and a movement direction are set by:
moving, at an address in an inner circumference part and an address in an outer circumference part of the optical disc, the objective lens in an inner circumference direction and in an outer circumference direction by using the actuator;
finding an offset value so as to cause a center level of amplitude of the tracking error signal obtained when crossing a track to approach a level of the tracking error signal obtained when tracking servo is in the on-state; and
conducting interpolation in other areas on the basis of results of the finding.

18. The optical disc apparatus according to claim 12, wherein in the seek processing an offset value which should be set according to a target address and a movement direction are set by:
moving, at an address of each of a plurality of areas obtained by dividing the optical disc, the objective lens in an inner circumference direction and in an outer circumference direction by using the actuator;
finding at that time an offset value so as to cause a center level of amplitude of the tracking error signal obtained when crossing a track to approach a level of the tracking error signal obtained when tracking servo is in the on-state; and
storing results of the finding as a table.

19. The optical disc apparatus according to claim 13, wherein in the seek processing an offset value which should be set according to a target address and a movement direction are set by:
moving, at an address in an inner circumference part and an address in an outer circumference part of the optical disc, the objective lens in an inner circumference direction and in an outer circumference direction by using the actuator;
finding at that time an offset value so as to cause a center level of amplitude of the tracking error signal obtained when crossing a track to approach a level of the tracking error signal obtained when tracking servo is in the on-state; and
conducting interpolation in other areas on the basis of results of the finding.

20. The optical disc apparatus according to claim 13, wherein in the seek processing an offset value which should be set according to a target address and a movement direction are set by:
moving, at an address of each of a plurality of areas obtained by dividing the optical disc, the objective lens in an inner circumference direction and in an outer circumference direction by using the actuator;
finding at that time an offset value so as to cause a center level of amplitude of the tracking error signal obtained when crossing a track to approach a level of the tracking error signal obtained when tracking servo is in the on-state; and
storing results of the finding as a table.

21. The optical disc apparatus according to claim 15, setting the offset value equal to a value suitable for data recording or reproducing after arriving at a target address is conducted when the tracking servo system is in an on-state.

22. The optical disc apparatus according to claim 5, setting the tilt adjustment quantity equal to a value suitable for data recording or reproducing after arriving at a target address is conducted when the tracking servo system is in an on-state.
